(19) United States
(12) Patent Application Publication
(10) Pub. No.: US 2006/0003884 A1
(43) Pub. Date: Jan. 5, 2006

(54) Alkali free glass

(75) Inventors: Manabu Nishizawa, Yokohama-shi (JP); Junichiro Kase, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY, LIMITED, Tokyo (JP)

(21) Appl. No.: 11/221,755

(22) Filed: Sep. 9, 2005

Related U.S. Application Data
(63) Continuation of application No. PCT/JP04/04626, filed on Mar. 31, 2004.

(30) Foreign Application Priority Data
Mar. 31, 2003 (JP) 2003-094993

(51) Int. Cl. C03C 3/078; C03C 3/091; C03C 3/087

(52) U.S. Cl. 501/72; 501/66; 501/70

(57) ABSTRACT

To present an alkali free glass capable of reducing compaction caused by heat treatment, without significantly increasing the strain point.

An alkali free glass characterized in that the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and less than 3.64.

### TECHNICAL FIELD

The present invention relates to an alkali free glass suitable for a substrate for display such as liquid crystal display or for a substrate for photomask.

### BACKGROUND ART

Heretofore, glass to be used for a display substrate, particularly for a display substrate having a thin film of metal or oxide formed in order to form electrodes or thin film transistors (TFT) on its surface, is required to be alkali free glass containing substantially no alkali metal oxides. Alkali free glass suitable for such a display substrate is disclosed in JP-A-8-109037, JP-A-9-169539, JP-A-10-72237, JP-A-2001-506223, JP-A-2002-29775 and JP-A-2003-503301.

Glass to be used for a display substrate is required not only to be alkali free glass but also to have such properties that (1) a deformation, particularly heat shrinkage (compaction) of the glass substrate caused by heating in the thin film-forming step, is little, (2) the durability (BHF resistance) to a buffered hydrofluoric acid (a mixture of hydrofluoric acid and ammonium fluoride) to be used for etching of SiOₓ or SiNₓ formed on the glass substrate, is high, (3) the durability (acid resistance) to etching with nitric acid, sulfuric acid, hydrochloric acid or the like to be used for etching of metal electrodes or ITO (tin-doped indium oxide) formed on the glass substrate, is high, (4) it has adequate durability against a basic resist-removing liquid, (5) the specific gravity (density) is small for weight reduction of the display, (6) the expansion coefficient is small in order to increase the temperature rising or falling rate or to improve the thermal shock resistance in the process for producing the display, and (7) it scarcely undergoes devitrification.

Among such properties required for alkali free glass to be used for a display substrate, with respect to the reduction of the deformation and/or compaction of the glass substrate caused by heating in a thin film-forming process, with conventional alkali free glass including alkali free glass disclosed in JP-A-8-109037, JP-A-9-169539, JP-A-10-72237, JP-A-2001-506223, JP-A-2002-29775 and JP-A-2003-503301, it has been common to increase the strain point of the glass. However, if the strain point is increased, it will be required to carry out the glass production process such as melting or forming at a higher temperature. Consequently, it will be required that the installation to be used for the glass production process, such as a melting furnace, be made to be durable for use at the higher temperature, and the useful life of such an installation becomes shorter, such being undesirable.

With respect to a thin film transistor (TFT) to be formed on a glass substrate as a driving circuit for a liquid crystal display, a transition from TFT (a-Si TFT) produced from an amorphous silicon film to TFT (p-Si TFT) produced from a polycrystalline silicon film by using a low temperature process, is progressing. However, as compared with a-Si TFT, with p-Si TFT, it is required to carry out the thin film-forming process at a higher temperature. This means that the strain point of the glass substrate is required to be made higher, and the production process is required to be carried out at a higher temperature. Further, one of the main reasons for the transition to p-TFT is to further refine and to further improve the performance of the display, and consequently, the display substrate is required to have a higher surface precision. This is also a reason for the requirement to reduce the compaction.

### DISCLOSURE OF THE INVENTION

It is a first object of the present invention to provide an alkali free glass which is capable of reducing compaction caused by heat treatment like a step of forming a thin film at the time of using it as a display substrate, without significantly increasing the strain point, in order to solve the above-mentioned problems of the prior art.

Further, it is a second object of the present invention to provide an alkali free glass having the following characteristics.

BHF resistance is high.

Acid resistance is high.

It has adequate durability against a basic resist-removing liquid.

The specific gravity (density) is small.

The expansion coefficient is small.

It scarcely undergoes devitrification.

In order to accomplish the above objects, the present invention provides an alkali free glass characterized in that the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and less than 3.64.

Further, the present invention provides an alkali free glass consisting essentially of the following constituting elements:

68%≦SiO₂≦80%

0%≦Al₂O₃<12%

0%<B₂O₃<7%

0%≦MgO≦12%

0%≦CaO≦15%

0%≦SrO≦4%

0%≦BaO≦1%

5%≦RO≦18%

wherein “%” is “mol %” on the basis that the total of the above constituting elements is 100%, and RO represents MgO+CaO+SrO+BaO.

Still further, the present invention provides an alkali free glass characterized in that it consists essentially of the following constituting elements, and the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and less than 3.64:

68%≦SiO₂≦80%

0%≦Al₂O₃<12%

0%<B₂O₃<7%

0%≦MgO≦12%

0%≦CaO≦15%

0%≦SrO≦4%

0%≦BaO≦1%

5%≦RO≦18%

wherein “%” is “mol %” on the basis that the total of the above constituting elements is 100%, and RO represents MgO+CaO+SrO+BaO.

In the alkali free glass of the present invention, it is preferred that the above-mentioned (Δₐₙ₋ₛₜ/α₅₀₋₃₅₀) is at least 0 and at most 3.5.

In the alkali free glass of the present invention, it is preferred that the content of the SiO₂ is 68%≦SiO₂≦75%.

In the alkali free glass of the present invention, it is preferred that the content of the Al₂O₃ is 5%≦Al₂O₃≦11.5%.

In the alkali free glass of the present invention, it is preferred that the content of the B₂O₃ is 2%≦B₂O₃≦7%.

In the alkali free glass of the present invention, it is preferred that the content of the MgO is 3%≦MgO≦10%.

In the alkali free glass of the present invention, it is preferred that the content of the CaO is 0.5%≦CaO≦12%.

In the alkali free glass of the present invention, it is preferred that the content of the RO is 5.5%≦RO≦18%.

In the alkali free glass of the present invention, it is preferred that the viscosity η_{L} at the liquidus temperature is at least 10^{3.8} dPa.s.

Still further, the present invention provides an alkali free glass characterized in that it consists essentially of the following constituting elements, the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and at most 3.5, and the viscosity η_{L} at the liquidus temperature is at least 10^{3.8} dPa.s:

68%≦SiO₂≦72.5%

8%≦Al₂O₃≦10.5%

4.5%≦B₂O₃<7%

3%≦MgO≦10%

2.5%≦CaO≦7%

0%≦SrO≦4%

0%≦BaO≦1%

5.5%≦RO≦18%

wherein “%” is “mol %” on the basis that the total of the above constituting elements is 100%, and RO represents MgO+CaO+SrO+BaO.

### BEST MODE FOR CARRYING OUT THE INVENTION

The alkali free glass of the present invention (hereinafter referred to as the glass of the present invention) contains substantially no alkali metal oxides. Specifically, the total content of alkali metal oxides is preferably at most 0.5 mol %.

The glass of the present invention is characterized in that the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and less than 3.64.

The compaction is a heat shrinkage of glass caused by relaxation of the glass structure at the time of heat treatment. The compaction can be obtained by the following formula from the density change.
C=(1−(d₀/d)^{1/3})×10⁶
C: compaction (ppm)
d₀: glass density before heat treatment (g/cm³)
d: glass density after heat treatment (g/cm³)

Thus, the compaction can be reduced by reducing the density change by the temperature change of glass.

As a result of an extensive study, the present inventors have found that if the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is made smaller than a specific value, the compaction caused by heat treatment can be reduced without significantly increasing the strain point.

Here, in the temperature range of from about the annealing point (Tₐₙ) to about the strain point (Tₛₜ), the equilibrium density curve can be substantially approximated to a straight line. Accordingly, in the present invention, Δₐₙ₋ₛₜ is meant for the inclination of this straight line.

In the glass of the present invention, the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and less than 3.64, whereby the compaction caused by heat treatment, will be reduced. Specifically, for example, the compaction obtained by the following procedure employed in Examples given hereinafter, is less than 190 ppm.

Definition of Compaction

Molten glass is formed into a plate shape, then heat-treated for one hour at a temperature in the vicinity of the annealing point and then annealed to room temperature at a cooling rate of 1° C./min. The obtained glass is formed into a prescribed shape, then heated to 900° C., heat-treated for one minute at that temperature and then cooled to room temperature at a cooling rate of 100° C./min to obtain sample A. Then, sample A is heated at a heating rate of 100° C./hr to a temperature (theoretical value) where the viscosity of glass becomes 17.8 dPa.s, heat-treated at that temperature for 8 hours and then annealed at a cooling rate of 100° C./hr to obtain sample B. The densities (dA and dB) of the obtained samples A and B are determined by a sink-float method. The compaction C (ppm) can be calculated by means of the following formula and the densities (dA and dB) thus obtained:
C=(1−(dA/dB)^{1/3})×10⁶

The sink-float method is a method wherein a mixture obtained by mixing bromoform and pentachloroethane so that the density becomes substantially equal to the density of glass, is put into a glass bottle, which is put into a water tank having a temperature gradient, whereby the position at which the glass sample stays, is measured to measure the density of the glass. The density value of the object glass is determined by comparison with a standard sample, of which the density value is known by preliminary measurement by an Archimedes method.

The temperature (theoretical value) at which the viscosity of glass becomes 17.8 dPa.s, can be obtained by Arrhenius plot using the annealing point (viscosity: 13.0 dPa.s) and the strain point (viscosity: 14.5 dPa.s) with the abscissa representing 1,000/T (K) and the ordinate representing the viscosity (dPa.s).

Δₐₙ₋ₛₜ/α₅₀₋₃₅₀ is preferably at most 3.50. When Δₐₙ₋ₛₜ/α₅₀₋₃₅₀ is at most 3.50, the compaction obtained by the above procedure may be at most 180 ppm. If the compaction obtained by the above procedure is at most 180 ppm, the compaction caused by heat treatment will be sufficiently reduced without significantly increasing the strain point. If the strain point increases, the melt viscosity of glass will increase, and consequently, it will be necessary to change the installation to be used for the glass production process such as a melting furnace, to one durable for use at a higher temperature. With the glass of the present invention, this problem has been resolved.

Δₐₙ₋ₛₜ/α₅₀₋₃₅₀ is more preferably at most 3.40, further preferably at most 3.20, still further preferably at most 3.00, particularly preferably at most 2.80.

The glass of the present invention can be produced by suitably selecting the constituting components for the glass, specifically the compositional ratio of the following seven components, so that Δₐₙ₋ₛₜ/α₅₀₋₃₅₀ will be at least 0 and less than 3.64.

The alkali free glass is constituted mainly by the following seven components:

SiO₂, Al₂O₃, B₂O₃

MgO, CaO, SrO, BaO

The three components identified in the upper line are components which mainly constitute the glass, and the four components identified in the lower line are fluxing components for melting the glass.

The present inventors have conducted experiments by changing the proportions of the above seven components in the glass and have found that there is the following relation between the seven components and Δₐₙ₋ₛₜ/α₅₀₋₃₅₀:

Δₐₙ₋ₛₜ/α₅₀₋₃₅₀ small SiO₂<Al₂O₃<B₂O₃ large
Small MgO<CaO<SrO large

Further, when the physical properties are taken into consideration, the following relation is considered to be satisfied:
Small MgO<CaO<SrO<BaO large

The present inventors have studied not only the conditions to bring Δₐₙ₋ₛₜ/α₅₀₋₃₅₀ to at least 0 and less than 3.64, but also other characteristics required for alkali free glass to be used for a display substrate, such as the BHF resistance, the acid resistance, the durability against a basic resist-removing liquid, the impact resistance, the resistance to devitrification, etc., and have found the following composition to be suitable for the alkali free glass of the present invention:

68%≦SiO₂≦80%

0%≦Al₂O₃<12%

0%<B₂O₃<7%

0%≦MgO≦12%

0%≦CaO≦15%

0%≦SrO≦4%

0%≦BaO≦1%

5%≦RO≦18%

wherein “%” is “mol %” on the basis that the total of the above constituting elements is 100%, and RO represents MgO+CaO+SrO+BaO.

Now, the composition of the glass of the present invention will be described, in which “mol %” will simply be represented by “%”.

SiO₂ is a network former and essential. As mentioned above, among the three components (SiO₂, Al₂O₃ and B₂O₃) constituting glass, SiO₂ makes Δₐₙ₋ₛₜ/α₅₀₋₃₅₀ the smallest. Accordingly, the glass of the present invention preferably has a high content of SiO₂. Specifically, the glass of the present invention has a content of SiO₂ being at least 68% and at most 80%. If the content of SiO₂ exceeds 80%, the melting property of the glass tends to be low, or the glass tends to be devitrified. The content of SiO₂ is preferably at most 75%, more preferably at most 74%, further preferably at most 73%, still further preferably at most 72.5%, particularly preferably at most 72%. When the content of SiO₂ is at most 72.5%, the glass will be excellent particularly in the formability and lowering of the devitrification temperature. However, if it is less than 68%, increase of the specific gravity (increase of the density), decrease of the strain point, increase of the expansion coefficient, decrease of the acid resistance, decrease of the alkali resistance or decrease of the BHF resistance tends to occur. The content of SiO₂ is preferably at least 69%, more preferably at least 70%.

Al₂O₃ is not essential, but is preferably incorporated to suppress the phase separation of the glass or to increase the strain point. However, as mentioned above, among the three components constituting glass, Al₂O₃ makes Δₐₙ₋ₛₜ/α₅₀₋₃₅₀ large as compared with SiO₂. Accordingly, the glass of the present invention preferably has a low content of Al₂O₃. Specifically, the glass of the present invention has an Al₂O₃ content of at least 0% and less than 12%. The content of Al₂O₃ is preferably at most 11.5%, more preferably at most 11.0%, further preferably at most 10.5%, still further preferably at most 10.0%, particularly preferably at most 9.5%. The lower limit is not particularly limited, and to suppress phase separation, it is preferably added in a suitable amount, and at least 5% is preferred. When Al₂O₃ is at least 5%, the glass will be excellent in the effect to suppress phase separation and the effect to increase the strain point. The content of Al₂O₃ is preferably at least 6%, more preferably at least 7%, further preferably at least 7.5%, particularly preferably at least 8%. When Al₂O₃ is at least 8%, the glass will be excellent particularly in the effect to suppress phase separation and the effect to increase the strain point.

The total content of SiO₂ and Al₂O₃ is preferably at least 76%, more preferably at least 77%, particularly preferably at least 79%. When this total content is at least 76%, the glass will be excellent in the effect to increase the strain point.

B₂O₃ is a component to reduce the specific gravity (density), to increase the BHF resistance, to increase the melting property of glass, to increase the resistance to devitrification or to reduce the expansion coefficient and thus essential. However, as mentioned above, among the three components constituting glass, it makes Δₐₙ₋ₛₜ/α₅₀₋₃₅₀ the largest. Accordingly, the glass of the present invention preferably has a low content of B₂O₃. B₂O₃ is a chemical substance specified in PRTR (Pollutant Release and Transfer Register), and also from the influence to the environment, it is preferred that the content of B₂O₃ is low. Specifically, the glass of the present invention has a B₂O₃ content of more than 0% and less than 7%. The lower limit is not particularly limited, but it is preferably at most 2%. When the content of B₂O₃ is at least 2%, the specific gravity (density) will be smaller, the BHF resistance and the melting property of glass will be excellent, the effect to reduce the expansion coefficient will be excellent, and the resistance to devitrification will increase. The content of B₂O₃ is preferably at least 3%, more preferably at least 4%, further preferably at least 4.5%, most preferably at least 5%. When the content of B₂O₃ is at least 4.5%, the glass will be excellent particularly in the formability, the reduction of the devitrification temperature and the BHF resistance. Further, it contributes also to the weight reduction of the substrate.

The total content of SiO₂ and B₂O₃ (SiO₂+B₂O₃) is preferably at least 75%, more preferably at least 77%, further preferably at least 78%, most preferably at least 79%. When this total content is at least 75%, the specific gravity (density) and the thermal expansion coefficient will have proper values.

Al₂O₃/B₂O₃ i.e. the content of Al₂O₃ divided by the content of B₂O₃, is preferably at most 2.0, more preferably at most 1.7, further preferably at most 1.6, particularly preferably at most 1.5. When Al₂O₃/B₂O₃ is at most 2.0, the glass will be excellent in the BHF resistance. On the other hand, Al₂O₃/B₂O₃ is preferably at least 0.8, and when it is at least 0.8, the glass will be excellent in the effect to increase the strain point. Al₂O₃/B₂O₃ is more preferably at least 0.9, particularly preferably at least 1.0.

(Al₂O₃+B₂O₃)/SiO₂ i.e. the total amount of Al₂O₃ and B₂O₃ divided by the content of SiO₂, is preferably at most 0.32, more preferably at most 0.31, particularly preferably at most 0.30, most preferably at most 0.29. If this value exceeds 0.32, the acid resistance is likely to deteriorate.

MgO is not essential, but is preferably incorporated to reduce the specific gravity (density) or increase the melting property of glass. If MgO exceeds 12%, the glass tends to undergo phase separation or devitrification, the BHF resistance tends to deteriorate, or the acid resistance tends to deteriorate. Further, with a view to suppressing the phase separation of glass, preventing the devitrification, or improving the BHF resistance and the acid resistance, the content of MgO is preferably at most 10%. When the content of MgO is at most 10%, the glass will be excellent in the melting property. The lower limit is not particularly limited. However, as mentioned above, among the fluxing components (MgO, CaO, SrO and BaO) for melting glass, MgO makes Δₐₙ₋ₛₜ/α₅₀₋₃₅₀ the smallest, and accordingly, the glass of the present invention preferably has a large content of MgO. Specifically, the glass of the present invention preferably has a MgO content of at least 2%, more preferably at least 3%, further preferably at least 4%, still further preferably at least 5%, particularly preferably at least 6%.

CaO is not essential, but may be incorporated up to 15% to reduce the specific gravity (density), to increase the melting property of glass or to improve the resistance to devitrification. If the content of CaO exceeds 15%, increase of the specific gravity (increase of the density) or increase of the expansion coefficient is likely to occur, or devitrification is rather likely to take place. CaO is preferably at most 12%, more preferably at most 10%, further preferably at most 8%, particularly preferably at most 7%, most preferably at most 6%. When CaO is incorporated, its content is preferably at least 0.5%, more preferably at least 1%, further preferably at least 2%, particularly preferably at least 2.5%. When the content of CaO is at least 2.5% and at most 7%, the glass will be excellent particularly in improvement of the devitrification characteristic while the melting property of glass is improved.

MgO/(MgO+CaO) i.e. the content of MgO divided by the total content of MgO and CaO, is preferably at least 0.2, more preferably at least 0.25, particularly preferably at least 0.4. When MgO/(MgO+CaO) is at least 0.2, the specific gravity (density) and the thermal expansion coefficient will have proper values, and such is preferred to minimize Δₐₙ₋ₛₜ/α₅₀₋₃₅₀ and also preferred to increase the Young's modulus.

SrO is not essential, but is a component to suppress phase separation of glass or to improve the resistance to devitrification and is preferably incorporated for the following reasons.

As mentioned above, among the fluxing components (MgO, CaO, SrO and BaO) for melting glass, MgO makes Δₐₙ₋ₛₜ/α₅₀₋₃₅₀ small, and accordingly, the glass of the present invention preferably has a large content of MgO. However, if MgO is incorporated in a large amount, the glass relatively tends to be devitrified. The present inventors have found that when SrO is incorporated in glass in a proper amount, the content of MgO can be made high without devitrification of glass. However, if SrO exceeds 4%, the specific gravity (density) of the glass tends to be too large. SrO is preferably at most 3%, more preferably at most 2.5%. However, in order to increase the content of MgO without devitrification of the glass, SrO is preferably incorporated in an amount of at least 0.1%, more preferably at least 0.5%, further preferably at least 1%, still further preferably at least 1.5%, particularly preferably at least 2%.

BaO is not essential, but may be incorporated up to 1% to suppress phase separation of glass or to improve the resistance to devitrification. Preferably, it is at most 0.5%. If BaO exceeds 1%, the specific gravity (density) tends to be too large. In a case where it is desired to reduce the specific gravity (density), it is preferred that no BaO is incorporated. BaO is specified as a poisonous substance in PRTR, and accordingly, it is preferred that no BaO is incorporated also from the viewpoint of the influence to the environment.

The total content of SrO and BaO (SrO+BaO) is preferably at most 6%, more preferably at most 4%. If this total content exceeds 6%, the specific gravity (density) is likely to be too large. In a case where it is desired to further reduce the specific gravity, or in a case where SiO₂+B₂O₃ is at most 79%, SrO+BaO is preferably at most 4%, more preferably at most 3%. Further, in a case where it is desired to improve the resistance to devitrification, SrO+BaO is preferably at least 0.5%, more preferably at least 1%, further preferably at least 2%.

In the glass of the present invention, the total content of MgO, CaO, SrO and BaO i.e. MgO+CaO+SrO+BaO (RO), is at least 5% and at most 18%. If RO exceeds 18%, the specific gravity (density) is likely to be too large, or the expansion coefficient is likely to be too large. RO is preferably at most 16.5%. When RO is at most 16.5%, the specific gravity and the expansion coefficient will have proper values.

Further, if MgO+CaO+SrO+BaO (RO) is less than 5%, the melting property of glass is likely to deteriorate. RO is more preferably at least 5.5%, further preferably at least 6%, particularly preferably at least 7%.

The glass of the present invention consists essentially of the above components, but may contain other components within a range not to impair the purpose of the present invention. The total content of such other components is preferably at most 10 mol %, more preferably at most 5%.

The following may be mentioned as such other components. Namely, SO₃, F, Cl, SnO₂, etc. may suitably be incorporated within the following ranges to improve the melting property, the refining agent or the formability.

So₃: from 0 to 2 mol %, preferably from 0 to 1 mol %

F: from 0 to 6 mol %, preferably from 0 to 3 mol %

Cl: from 0 to 6 mol %, preferably from 0 to 4 mol %

SnO₂: from 0 to 4 mol %, preferably from 0 to 1 mol %

Here, in a case where other components are to be incorporated, the total content is up to 10 mol %, preferably up to 5 mol %, more preferably up to 3 mol %, particularly preferably up to 2 mol %, further preferably within a range of from 1 ppm to 2 mol %.

Further, for the same reasons, Fe₂O₃, ZrO₂, TiO₂, Y₂O₃ or the like may be incorporated in the following ranges.

Fe₂O₃: from 0 to 1 mol %, preferably from 0 to 0.1 mol %

ZrO₂: from 0 to 2 mol %, preferably from 0 to 1 mol %

TiO₂: from 0 to 4 mol %, preferably from 0 to 2 mol %

Y₂O₃: from 0 to 4 mol %, preferably from 0 to 2 mol %

CeO₂: from 0 to 2 mol %, preferably from 0 to 1 mol %

When the above-mentioned other components are to be incorporated, their total content (SO₃+F+Cl+SnO₂+Fe₂O₃+ZrO₂+TiO₂+Y₂O₃+CeO₂) is up to 15 MOL %, preferably up to 10 mol %, more preferably up to 5 mol %, particularly preferably up to 3 mol %, further preferably within a range of from 1 ppm to 3 mol %.

Further, when the environmental aspect and recycling are taken into consideration, it is preferred that As₂O₃, Sb₂O₃, PbO, ZnO and P₂O₅ are not substantially incorporated. Namely, the content of each of these five components is preferably at most 0.1%. More preferably, the contents of these five components are at most 0.1% in total.

However, with respect to ZnO, although it is preferably not substantially contained especially when forming is carried out by a float process, it may be contained optionally in an amount exceeding 0.1% when forming is carried out by another forming method such as a down draw method. Especially when it is desired to increase the resistance against devitrification, it is preferably contained within a range of up to 2%. If the content of ZnO exceeds 2%, the specific gravity (density) is likely to be too large.

Further, As₂O₃ or Sb₂O₃, particularly Sb₂O₃, may be incorporated optionally in an amount exceeding 0.1%, when it is desired to further improve clearness.

TiO₂ is preferably not substantially contained when forming is carried out by a float process, but may be contained optionally in an amount exceeding 0.1% when forming is carried out by another forming method such as a down draw method. Especially when it is desired to increase the resistance against devitrification, it is preferred to incorporate TiO₂ within a range of up to 2%. If the content of TiO₂ exceeds 2%, the specific gravity (density) is likely to be too large.

The specific gravity (density) of the glass of the present invention is preferably at most 2.46 g/cm³. The specific gravity of the glass being at most 2.46 g/cm³ is advantageous for the weight reduction of a display. The specific gravity of the glass is more preferably at most 2.43 g/cm³, further preferably at most 2.40 g/cm³, particularly preferably at most 2.39 g/cm³, most preferably at most 2.38 g/cm³.

The average linear expansion coefficient α₅₀₋₃₅₀ at from 50 to 350° C. of the glass of the present invention, is preferably at most 3.4×10⁻⁶/° C., more preferably at most 3.2×10⁻⁶/° C., particularly preferably at most 3.0×10⁻⁶/° C., most preferably at most 2.9×10⁻⁶/° C. When α₅₀₋₃₅₀ is at most 3.4×10⁻⁶/° C., the glass will be excellent in thermal shock resistance. Further, α₅₀₋₃₅₀ is preferably at least 2.4×10⁻⁶/° C., and when it is at least 2.4×10⁻⁶/° C., in a case where a SiOₓ or SiNₓ film is formed on such a glass substrate, matching in expansion will be excellent between such a glass substrate and such a film. From such a viewpoint, α₅₀₋₃₅₀ is more preferably at least 2.6×10⁻⁶/° C., further preferably at least 2.7×10⁻⁶/° C.

In order to reduce compaction, specifically to a level of less than 190 ppm, Δₐₙ₋ₛₜ (ppm/° C.) is preferably at least 0 and less than 12.0.

The strain point of the glass of the present invention is preferably at least 650° C., more preferably at least 660° C., further preferably at least 670° C., still further preferably at least 680° C., particularly preferably at least 690° C.

The temperature T₂ at which the viscosity of the glass of the present invention becomes 10² dPa.s, is preferably at most 1,840° C., more preferably at most 1,820° C., further preferably at most 1,800° C., particularly preferably at most 1,780° C., most preferably at most 1,760° C. T₂ being at most 1,840° C. is preferred for melting the glass.

The temperature T₄ at which the viscosity of the glass of the present invention becomes 10⁴ dPa.s, is preferably at most 1,380° C. T₄ being at most 1,380° C. is preferred for forming the glass. It is more preferably at most 1,360° C., particularly preferably at most 1,350° C., most preferably at most 1,340° C.

The viscosity η_{L} at the liquidus temperature of the glass of the present invention is preferably at least 10^{3.5} dPa.s. η_{L} being at least 10^{3.5} dPa.s is preferred for forming the glass. η_{L} is particularly preferably at least 10^{3.8} dPa.s from the viewpoint of forming the glass by a float process and since the devitrification temperature of the glass can be lowered. η_{L} is further preferably at least 10⁴ dPa.s, most preferably at least 10^{4.1} dPa.s.

Especially when forming is carried out by a float process, even if Δₐₙ₋ₛₜ/α₅₀₋₃₅₀ is less than 3.64, η_{L} is preferably at least 10^{3.8} dPa.s when the forming property is taken into consideration. Accordingly, among Examples 1 to 5 given hereinafter, the glass of Example 4 is good from the aspect of the forming property.

Thus, a preferred embodiment of the glass of the present invention is an alkali free glass characterized in that it has the following composition, Δₐₙ₋ₛₜ/α₅₀₋₃₅₀ is at least 0 and at most 3.5, and the viscosity η_{L} at the liquidus temperature is at least 10^{3.8} dPa.s:

68%≦SiO₂≦72.5%

8%≦Al₂O₃≦10.5%

4.5%≦B₂O₃<7%

3%≦MgO≦10%

2.5%≦CaO≦7%

0%≦SrO≦4%

0%≦BaO≦1%

5.5%≦RO≦18%

It is preferred that when the glass of the present invention is immersed in an aqueous hydrochloric acid solution having a concentration of 0.1 mol/liter at 90° C. for 20 hours, there will be no turbidity, color change or cracks formed on its surface. Further, the weight loss (ΔW_{HCl}) per unit surface area of the glass obtained from the surface area of the glass and the mass change of the glass by the above immersion, is preferably at most 0.6 mg/cm². ΔW_{HCl} is more preferably at most 0.4 mg/cm², particularly preferably at most 0.2 mg/cm², most preferably at most 0.15 mg/cm².

Further, it is preferred that when the glass of the present invention is immersed at 25° C. for 20 minutes in a mixture (hereinafter referred to as a buffered hydrofluoric acid (BHF) mixture) prepared by mixing an aqueous ammonium fluoride solution having a mass percentage concentration of 40% and an aqueous hydrofluoric acid solution having the mass percentage concentration of 50%, there will be no turbidity formed at its surface. Hereinafter, evaluation by means of this buffered hydrofluoric acid mixture will be referred to as evaluation of BHF resistance, and a case where no turbidity is formed at the surface is regarded as a case where the BHF resistance is good. Further, the weight loss (ΔW_{BHF}) per unit area of the glass obtained from the surface area of the glass and the mass change of the glass by the above immersion, is preferably at most 0.6 mg/cm². ΔW_{BHF} is more preferably at most 0.5 mg/cm², further preferably at most 0.4 mg/cm².

The method for producing the glass of the present invention is not particularly limited, and various production processes may be employed. For example, starting materials commonly used, are mixed to have the desired composition, and the mixture is heated and melted in a melting furnace at a temperature of from 1,600° C. to 1,650° C. The glass is homogenized by e.g. bubbling, addition of a clarifier or stirring. When it is to be used as a substrate for display such as liquid crystal display or a substrate for photomask, it is formed into a prescribed thickness by a well known method such as a press method, a down draw method or a float process and annealed, followed by processing such as grinding or polishing to obtain a substrate having a prescribed size and shape.

Accordingly, the size of the glass of the present invention is optional and suitably selected at the time of the production. However, the glass of the present invention is particularly useful for a large size glass substrate. Namely, even if the compaction i.e. the heat shrinkage ratio of glass, is the same, the amount of the heat shrinkage (the absolute value of the heat shrinkage) as a whole of the substrate will increase as the size of the substrate increases. For example, if the size of a display substrate is changed from 20 inch (50.8 centimeter) diagonal to 25 inch (63.5 centimeter) diagonal, the length of the diagonal line of the substrate will correspondingly be longer, and the amount of the heat shrinkage as a whole of the substrate will also increase. With the glass of the present invention, the compaction caused by heat treatment is reduced as mentioned above, and the amount of the heat shrinkage as a whole of the substrate is also reduced. Such an effect becomes remarkable as the size of the substrate increases.

The size of the glass of the present invention is preferably at least 30 centimeter square, more preferably at least 40 centimeter square, further preferably at least 80 centimeter square, still further preferably at least 1 meter square, still further preferably at least 1.5 meter square, particularly preferably at least 2 meter square. The thickness of the glass is preferably from 0.3 to 1.0 mm.

### EXAMPLES

### Examples 1 to 5 and Comparative Example

Starting materials were mixed to have a composition shown by mol % in the lines for SiO₂ to BaO in Table 1 and melted at a temperature of from 1,600 to 1,650° C. by means of a platinum crucible. At that time, stirring was carried out by means of a platinum stirrer to-homogenize the glass. Then, the molten glass was cast to form a plate, heat-treated for one hour at a temperature in the vicinity of the annealing point expected from the glass composition and then annealed at a cooling rate of 1° C./min to obtain a glass. In such a manner, glasses of Examples 1 to 5 and Comparative Example were obtained.

Measurement of the Average Linear Expansion Coefficient

The glass obtained in each of Examples 1 to 5 and Comparative Example was processed into a prescribed circular cylinder, then heated to a temperature in the vicinity of the annealing point (Tₐₙ), heat-treated at that temperature for one hour and then annealed at a cooling rate of 1° C./min to obtain a sample, and by using the sample and the differential thermal expansion analyzer (TMA), the average linear expansion coefficient (α₅₀₋₃₅₀) within a range of from 50 to 350° C. was measured by the method stipulated in JIS R3102.

Preparation of Equilibrium Density Curve of Glass

The glass obtained in each of Examples 1 to 5 and Comparative Example was polished to have a sample having about 4 cm square and a thickness of 2 mm. The obtained glass sample was heat-treated for 16 hours at a plurality of temperatures from the annealing point (Tₐₙ) to the strain point (Tₛₜ) and then dropped and quenched on a carbon plate. The cooled sample was subjected to a so-called Archimedes method (JIS Z8807, section 4) to measure the density. In this procedure, the measurement was carried out repeatedly to confirm the reproducibility to the digit of 0.0001 g/cm³. From the results of measurements of the densities at a plurality of temperatures, the inclination of the change in the density to the heat treatment temperature was regressed to prepare the equilibrium density curve, whereupon the equilibrium curve gradient Δₐₙ₋ₛₜ (ppm/° C.) in a temperature range of from about the annealing point (Tₐₙ) to about the strain point (Tₛₜ) was obtained.

From α₅₀₋₃₅₀ and Δₐₙ₋ₛₜ thus obtained, Δₐₙ₋ₛₜ/α₅₀₋₃₅₀ was obtained by calculation.

Measurement of Compaction

The glass obtained in each of Examples 1 to 5 and Comparative Example was polished to have an about 5 mm square and a thickness of 0.7 mm. The obtained glass was heated to 900° C., heat-treated at that temperature for one minute and then cooled to room temperature at a cooling rate of 100° C./min to obtain sample A. Then, sample A was heated at a heating rate of 100° C./hr to a temperature (theoretical value) at which the viscosity of the glass would be 17.8 dPa.s, heat-treated at that temperature for 8 hours and then annealed at a cooling rate of 100° C./hr to obtain sample B. The densities (dA and dB) of the obtained samples A and B were determined by a sink-float method. Using the densities (dA and dB) thus obtained and the following formula, compaction C (ppm) was calculated.
C=(1−(dA/dB)^{1/3})×10⁶

The temperature at which the viscosity of the glass would be 17.8 dPa.s was obtained by Arrhenius plotting by using the annealing point (Tₐₙ) (viscosity: 13.0 dPa.s) and the strain point (Tₛₜ) (viscosity: 14.5 dPa.s) with the abscissa representing 1,000/T (K) and the ordinate representing the viscosity (dPa.s). Here, the annealing point (Tₐₙ) and the strain point (Tₛₜ) were measured by the methods stipulated in JIS R3103.

T₂, T₄, η_{L}

The temperature T₂ (unit: ° C.) at which the viscosity of the glass obtained in each of Examples 1 to 5 and Comparative Example becomes 102.0 dPa.s and the temperature T₄ (unit: ° C.) at which the viscosity becomes 10⁴ dPa.s, were measured by means of a rotation viscometer.

Further, from a temperature-viscosity curve obtained by the rotation viscometer and the liquidus temperature, the viscosity η_{L} (unit: dPa.s) at the liquidus temperature was obtained. With respect to the liquidus temperature, a plurality of glass pieces were melted under heating for 17 hours at the respectively different temperatures, and an average value between the glass temperature of glass having the highest temperature among glasses having crystals precipitated therein, and the glass temperature of glass having the lowest temperature among glasses having no crystals precipitated, was taken as the liquidus temperature.

HCl Resistance (ΔW_{HCl})

The glass obtained in each of Examples 1 to 5 and Comparative Example was immersed at 90° C. for 20 hours in an aqueous hydrochloric acid solution having a concentration of 0.1 mol/liter, whereby the mass change of the glass between before and after the immersion was obtained, and from the mass change and the surface area of the glass, the weight loss (ΔW_{HCl} (mg/cm²)) per unit surface area of the glass was obtained.

BHF Resistance (ΔW_{BHF}, Turbidity)

The glass obtained in each of Examples 1 to 5 and Comparative Example was immersed at 25° C. for 20 minutes in a buffered hydrofluoric acid (BHF) (mixture obtained by mixing an aqueous ammonium fluoride solution having a mass percentage concentration of 40% and an aqueous hydrofluoric acid solution having the mass percentage concentration of 50% in a volume ratio of 9:1), and the mass change of the glass between before and after the immersion was obtained, and from this mass change and the surface area of the glass, the weight loss (ΔW_{BHF} (mg/cm²)) per unit surface area of the glass was obtained. Further, presence or absence of turbidity at the glass surface after the immersion was visually confirmed. Here, a case where no turbidity was observed at the glass surface, was evaluated to be a case where the BHF resistance was good (evaluation: ◯).

These results are shown in Table 1. Here, the specific gravity (density) (g/cm³) is a numerical value converted from the density of a sample quenched from the annealing point (Tₐₙ), obtained in the procedure for preparing the equilibrium density curve.

### Examples 6 to 14

In the same manner as in Example 1, starting materials are mixed to have a composition shown in Table 1 and melted in a melting furnace to obtain a molten glass, which is formed into a plate, followed by annealing to obtain a glass. In such a manner, glasses of Examples 6 to 14 are obtained. With respect to each glass obtained, α₅₀₋₃₅₀, the specific gravity (density), the strain point (Tₛₜ), the annealing point (Tₐₙ), T₂ and T₄ are obtained. With respect to Δₐₙ₋ₛₜ, the contribution degree aᵢ to Δ of each glass component (each of 6 components of SiO₂, Al₂O₃, B₂O₃, MgO, CaO and SrO) (i=1 to 6 (the above 6 components)), is obtained by a regression calculation, and it is obtained by calculation from ΣaᵢXᵢ+b (Xᵢ is the mol fraction of each glass component, and b is a constant). In the same manner as for Δₐₙ₋ₛₜ, α₅₀₋₃₅₀, the specific gravity (density), the strain point (Tₛₜ), the annealing point (Tₐₙ), T₂ and T₄ are also obtained by calculation from the contribution degree of each glass component. With respect to compaction, Δ and C (compaction) are linearly regressed, and the compaction is obtained by calculation based on the regression formula. The results obtained are shown in Table 1.

TABLE 1

| | | | Comp. | | | | | | | |
|---|---|---|---|---|---|---|---|---|---|---|
| | Ex. 1 | Ex. 2 | Ex. | Ex. 3 | Ex. 4 | Ex. 5 | Ex. 6 | Ex. 7 | Ex. 8 | Ex. 9 |
| | mol % | mol % | mol % | mol % | mol % | mol % | mol % | mol % | mol % | mol % |
| SiO₂ | 70.5 | 71.1 | 70.0 | 71.6 | 72.1 | 72.7 | 72.1 | 70.0 | 70.5 | 70.8 |
| Al₂O₃ | 10.1 | 9.5 | 11.0 | 9.0 | 8.5 | 7.8 | 9.5 | 10.5 | 9.8 | 9.7 |
| B₂O₃ | 6.7 | 6.2 | 7.0 | 5.6 | 5.1 | 4.6 | 5.1 | 6.9 | 6.8 | 6.6 |
| MgO | 4.5 | 6.0 | 2.5 | 7.5 | 9.0 | 10.5 | 8.0 | 3.8 | 3.0 | 0.0 |
| CaO | 6.0 | 5.1 | 7.5 | 4.2 | 3.2 | 2.3 | 3.2 | 6.7 | 7.8 | 10.8 |
| SrO | 2.2 | 2.1 | 2.0 | 2.1 | 2.1 | 2.1 | 2.1 | 2.1 | 2.1 | 2.1 |
| BaO | 0.0 | 0.0 | 0.0 | 0.0 | 0.0 | 0.0 | 0.0 | 0.0 | 0.0 | 0.0 |
| RO | 12.7 | 13.2 | 12.0 | 13.8 | 14.3 | 14.9 | 13.3 | 12.6 | 12.9 | 12.9 |
| SiO₂ + Al₂O₃ | 80.6 | 80.6 | 81.0 | 80.6 | 80.6 | 80.5 | 81.6 | 80.5 | 80.3 | 80.5 |
| SiO₂ + B₂O₃ | 77.2 | 77.3 | 77.0 | 77.2 | 77.2 | 77.3 | 77.2 | 76.9 | 77.3 | 77.4 |
| Al₂O₃ + B₂O₃ | 16.8 | 15.7 | 18.0 | 14.6 | 13.6 | 12.4 | 14.6 | 17.4 | 16.6 | 16.3 |
| Al₂O₃/B₂O₃ | 1.51 | 1.53 | 1.57 | 1.61 | 1.67 | 1.70 | 1.86 | 1.52 | 1.44 | 1.47 |
| MgO/(MgO + CaO) | 0.43 | 0.54 | 0.25 | 0.64 | 0.74 | 0.83 | 0.71 | 0.36 | 0.28 | 0.00 |
| SrO + BaO | 2.2 | 2.1 | 2.0 | 2.1 | 2.1 | 2.1 | 2.1 | 2.1 | 2.1 | 2.1 |
| Total | 100.0 | 100.0 | 100.0 | 100.0 | 100.0 | 100.0 | 100.0 | 100.0 | 100.0 | 100.0 |

| | Ex. 1 | Ex. 2 | Comp. E | Ex. 3 | Ex. 4 | Ex. 5 | Ex. 6 | Ex. 7 | Ex. 8 | Ex. 9 |
|---|---|---|---|---|---|---|---|---|---|---|
| Δₐₙ₋ₛₜ (ppm/° C.) | 10.1 | 9.7 | 12.0 | 9.1 | 8.6 | 8.2 | 7.3 | 11.3 | 11.3 | 11.3 |
| α₅₀₋₃₅₀ (×10⁻⁶/° C.) | 3.15 | 3.19 | 3.30 | 3.24 | 3.21 | 3.20 | 3.10 | 3.31 | 3.44 | 3.67 |
| Δₐₙ₋ₛₜ/α₅₀₋₃₅₀ | 3.21 | 3.04 | 3.64 | 2.81 | 2.68 | 2.56 | 2.36 | 3.40 | 3.27 | 3.09 |
| Compaction (ppm) | 178 | 165 | 190 | 149 | 137 | 122 | 98 | 185 | 185 | 186 |
| Specific gravity | 2.424 | 2.424 | 2.424 | 2.436 | 2.435 | 2.435 | 2.431 | 2.439 | 2.443 | 2.458 |
| (density: g/cm³) | | | | | | | | | | |
| Strain point (° C.) | 698 | 699 | 699 | 683 | 683 | 682 | 689 | 683 | 682 | 687 |
| Annealing point | 750 | 751 | 751 | 747 | 748 | 746 | 756 | 748 | 744 | 744 |
| (° C.) | | | | | | | | | | |
| T₂ (° C.) | 1746 | 1750 | 1742 | 1773 | 1773 | 1774 | 1781 | 1768 | 1778 | 1792 |
| T₄ (° C.) | 1332 | 1334 | 1332 | 1329 | 1327 | 1325 | 1343 | 1331 | 1335 | 1350 |
| ΔW_{HC1} (mg/cm²) | 0.03 | 0.03 | 0.06 | 0.05 | 0.05 | 0.05 | — | — | — | — |
| ΔW_{BHF} (mg/cm²) | 0.45 | 0.46 | 0.46 | 0.50 | 0.52 | 0.55 | — | — | — | — |
| BHF resistance | ◯ | ◯ | ◯ | ◯ | ◯ | ◯ | — | — | — | — |
| (turbidity) | | | | | | | | | | |
| η_{L} (dPa · s) | 10^{4.0} | 10^{4.3} | 10^{4.2} | 10^{4.1} | 10^{3.8} | 10^{3.6} | — | — | — | — |
| Liquid phase | 1331 | 1287 | 1300 | 1315 | 1355 | 1345 | — | — | — | — |
| temperature (° C.) | | | | | | | | | | |

| | Ex. 10 | Ex. 11 | Ex. 12 | Ex. 13 | Ex. 14 |
|---|---|---|---|---|---|
| | mol % | mol % | mol % | mol % | mol % |
| SiO₂ | 70.7 | 72.1 | 72.9 | 73.9 | 70.5 |
| Al₂O₃ | 9.6 | 10.8 | 9.0 | 8.0 | 10.1 |
| B₂O₃ | 6.8 | 6.9 | 6.3 | 6.3 | 6.5 |
| MgO | 1.5 | 2.2 | 7.7 | 5.7 | 4.2 |
| CaO | 9.3 | 4.0 | 2.0 | 4.0 | 5.6 |
| SrO | 2.1 | 4.0 | 2.1 | 2.1 | 3.1 |
| BaO | 0.0 | 0.0 | 0.0 | 0.0 | 0.0 |
| RO | 12.9 | 10.2 | 11.8 | 11.8 | 12.9 |
| SiO₂ + A₂O₃ | 80.3 | 82.9 | 81.9 | 81.9 | 80.6 |
| SiO₂ + B₂O₃ | 77.5 | 79.0 | 79.2 | 80.2 | 77.0 |
| Al₂O₃ + B₂O₃ | 16.4 | 17.7 | 15.3 | 14.3 | 16.6 |
| Al₂O₃/B₂O₃ | 1.41 | 1.57 | 1.43 | 1.27 | 1.55 |
| MgO/(MgO + CaO) | 0.14 | 0.35 | 0.79 | 0.59 | 0.43 |
| SrO + BaO | 2.1 | 4.0 | 2.1 | 2.1 | 3.1 |
| Total | 100.0 | 100.0 | 100.0 | 100.0 | 100.0 |

| | Ex. 10 | Ex. 11 | Ex. 12 | Ex. 13 | Ex. 14 |
|---|---|---|---|---|---|
| Δₐₙ₋ₛₜ (ppm/° C.) | 11.5 | 10.4 | 8.4 | 8.5 | 10.8 |
| α₅₀₋₃₅₀ (×10⁻⁶/° C.) | 3.56 | 3.11 | 3.31 | 3.44 | 3.67 |
| Δₐₙ₋ₛₜ/α₅₀₋₃₅₀ | 3.22 | 3.33 | 2.88 | 2.73 | 3.21 |
| Compaction (ppm) | 187 | 180 | 130 | 131 | 182 |
| Specific gravity | 2.449 | 2.431 | 2.439 | 2.443 | 2.458 |
| (density: g/cm³) | | | | | |
| Strain point (° C.) | 683 | 689 | 683 | 682 | 687 |
| Annealing point (° C.) | 742 | 756 | 747 | 741 | 748 |
| T₂ (° C.) | 1786 | 1806 | 1806 | 1829 | 1765 |
| T₄ (° C.) | 1341 | 1391 | 1351 | 1365 | 1341 |
| ΔW_{HC1} (mg/cm²) | — | — | — | — | — |
| ΔW_{BHF} (mg/cm²) | — | — | — | — | — |
| BHF resistance (turbidity) | — | — | — | — | — |
| η_{L} (dPa · s) | — | — | — | — | — |
| Liquid phase temperature (° C.) | — | — | — | — | — |

### INDUSTRIAL APPLICABILITY

The glass of the present invention is capable of reducing compaction caused by heat treatment without significantly increasing the strain point. Accordingly, it is possible to reduce compaction caused by heat treatment in e.g. a step for forming a thin film on a display substrate, to at most the level required for a display substrate, without (significantly) increasing the temperature for the glass production process such as melting or forming.

Accordingly, the glass of the present invention is useful for a display substrate, particularly for a display substrate required to have a high surface precision, despite it is heat-treated at a relatively high temperature, like an active matrix type LCD display substrate which will have p-Si TFT formed on its surface.

Further, even if the compaction is the same, the amount of heat shrinkage increases as a whole of the substrate, as the size of the glass substrate increases. Accordingly, the effect of the glass of the present invention to reduce the compaction is remarkable particularly in a large size display substrate.

The glass of the present invention has various useful characteristics as a glass substrate for display. Namely, because of the low specific gravity (low density), a display such as a liquid crystal display can be made light in weight, and because of the low expansion coefficient, the production efficiency can be increased. Further, it is possible to provide a display substrate which is excellent in the durability against e.g. hydrochloric acid to be used for etching of e.g. ITO, or which is excellent in the durability against a buffered hydrofluoric acid to be used for etching of SiOₓ or SiNₓ. Further, it is possible to obtain glass having resistance against devitrification, whereby the production efficiency can be increased.

The entire disclosure of Japanese Patent Application No. 2003-094993 filed on Mar. 31, 2003 including specification, claims and summary is incorporated herein by reference in its entirety.

What is claimed is:

1. An alkali free glass characterized in that the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and less than 3.64.

2. An alkali free glass consisting essentially of the following constituting elements:
68%≦SiO₂≦80%
0%≦Al₂O₃<12%
0%<B₂O₃<7 %
0%≦MgO≦12%
0%≦CaO≦15%
0%≦SrO≦4%
0%≦BaO≦1%
5%≦RO≦18%
wherein “%” is “mol %” on the basis that the total of the above constituting elements is 100%, and RO represents MgO+CaO+SrO+BaO.

3. The alkali free glass according to claim 1, characterized by consisting essentially of the following constituting elements:
68%≦SiO₂≦80%
0%≦Al₂O₃<12%
0%<B₂O₃<7%
0%≦MgO≦12%
0%≦CaO≦15%
0%≦SrO≦4%
0%≦BaO≦1%
5%≦RO≦18%
wherein “%” is “mol %” on the basis that the total of the above constituting elements is 100%, and RO represents MgO+CaO+SrO+BaO.

4. The alkali free glass according to claim 1, wherein the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and at most 3.5.

5. The alkali free glass according to claim 2, wherein the content of the SiO₂ is 68%≦SiO₂≦75%.

6. The alkali free glass according to claim 2, wherein the content of the Al₂O₃ is 5%≦Al₂O₃≦11.5%.

7. The alkali free glass according to claim 2, wherein the content of the B₂O₃ is 2%≦B₂O₃<7%.

8. The alkali free glass according to claim 2, wherein the content of the MgO is 3%≦MgO≦10%.

9. The alkali free glass according to claim 2, wherein the content of the CaO is 0.5%≦CaO≦12%.

10. The alkali free glass according to claim 2, wherein the content of the RO is 5.5%≦RO≦18%.

11. The alkali free glass according to claim 1, wherein the viscosity η_{L} at the liquidus temperature is at least 10^{3.8} dPa.s.

12. An alkali free glass characterized in that it consists essentially of the following constituting elements, the ratio (Δₐₙ₋ₛₜ/α₅₀₋₃₅₀) of the equilibrium density curve gradient Δₐₙ₋ₛₜ (ppm/° C.) in a temperature range of from about the annealing point (Tₐₙ) to about the strain point (Tₛₜ) to the average linear expansion coefficient α₅₀₋₃₅₀ (×10⁻⁶/° C.) in a range of from 50 to 350° C., is at least 0 and at most 3.5, and the viscosity η_{L} at the liquidus temperature is at least 10^{3.8} dPa.s:
68%≦SiO₂≦72.5%
8%≦Al₂O₃≦10.5%
4.5%≦B₂O₃<7%
3%≦MgO≦10%
2.5%≦CaO≦7%
0%≦SrO≦4%
0%≦BaO≦1%
5.5%≦RO≦18%
wherein “%” is “mol %” on the basis that the total of the above constituting elements is 100%, and RO represents MgO+CaO+SrO+BaO.
